(19) United States
(12) Patent Application Publication
(10) Pub. No.: US 2019/0253707 A1
(43) Pub. Date: Aug. 15, 2019

(54) VIDEO CODING METHOD AND APPARATUS UTILIZING ADAPTIVE INTERPOLATION FILTER

(71) Applicant: DIGITALINSIGHTS INC., Seoul (KR)

(72) Inventors: Hochan RYU, Seoul (KR); Yongjo AHN, Seoul (KR)

(21) Appl. No.: 16/343,582

(22) PCT Filed: Oct. 20, 2016
(86) PCT No.: PCT/KR2016/011777

§ 371 Date: Apr. 19, 2019

(30) Foreign Application Priority Data
Oct. 19, 2016 (KR) 10-2016-0135432

(51) Int. Cl. H04N 19/117; H04N 19/132; H04N 19/105; H04N 19/70; H04N 19/159

(52) U.S. Cl. CPC H04N 19/117; H04N 19/132; H04N 19/176; H04N 19/70; H04N 19/159; H04N 19/105

(57) ABSTRACT

The present invention relates to an interpolation filter, and method and apparatus, from among video coding schemes, for encoding and decoding by selectively utilizing the interpolation filter. The method includes the steps of: acquiring spatially and temporally adjacent reference samples; determining whether to an adaptive apply interpolation filter acquired from a bitstream; and, if whether to apply the adaptive interpolation filter is indicated to be true, then carrying out interpolation of the reference samples by utilizing data for the acquired reference samples and interpolation filter.

### TECHNICAL FIELD

The present invention relates to an image processing technique and, more particularly, to a method and apparatus for performing interpolation by selecting a specific filter from among a plurality of interpolation filters in a video compression technique.

### BACKGROUND ART

The demand for multimedia information is increasing due to diversification and miniaturization of multimedia devices, and thus there has been a need for a high efficiency video compression technology for next generation video services. Based on such a need, the MPEG and VCEG jointly established the Joint Collaborative Team on Video Coding (JCT-VC) of the video compression standardization of H.264/AVC, and completed the standardization for HEVC, which is the latest international video compression standard established January 2013.

In video compression technology, pixel interpolation techniques are used for intra prediction and inter prediction, as a technique of generating a pixel of real-precision between two pixels of integer precision. in the exist video coding standard H.264/AVC, a 6-tap interpolation filter is adopted, and in HEVC, 8-tap and 7-tap interpolation filters are adopted. The number of taps of the interpolation filter is an element technology that greatly affects the encoding and decoding complexity, as well as the encoding efficiency through precise reference pixel generation in generating pixels of real precision.

Recently, interpolation filters having higher number of taps have been proposed in accordance with an increase in resolution of an image and an improvement in computing rower, and various techniques for generating reference pixels having high precision have been studied variously. However, since the resolution of the image increases, the spatial similarity) between pixels increases, the improvement of the coding efficiency is affected due to the interpolation filter. That is, in the case of a high resolution image, as the spatial similarity between pixels increases, the interpolation filter limits an increase in the encoding efficiency, as compared to low resolution image.

### DISCLOSURE

### Technical Problem

An object of the present invention is to provide method and an apparatus for selecting a pixel interpolation filter used in intra prediction and intra prediction to be adaptively used in consideration of image resolution, encoding and decoding environment, encoding efficiency, and the like.

It is to be understood, however, that the technical problem of the present invention is not limited to the above-described technical problem, and other technical problems may exist.

### Technical Solution

In order to achieve the objects, a video encoding and decoding method and apparatus according to an embodiment of the present invention includes an acquiring unit acquiring a spatially and temporally adjacent reference samples; a determining unit determining whether to apply an adaptive interpolation filter acquired from a bitstream; and when whether to apply the adaptive interpolation filter is indicated to true, a performing unit performing interpolation of the reference samples using information for the acquired reference samples and the interpolation filter.

In order to achieve the objects, a video encoding and decoding method and apparatus according to an embodiment or the present invention includes an acquiring unit acquiring whether to apply the adaptive interpolation filter through a high level syntax of one of a sequence parameter set (SPS), a picture parameter set (PPS), and a slice header.

In order to achieve the objects, a video encoding and decoding method and apparatus according to an embodiment or the present invention includes an acquiring unit acquiring whether to apply the adaptive interpolation filter for intra prediction through a high level syntax of one of a sequence parameter set (SPS), a picture parameter set (PPS), and a slice header; an acquiring unit acquiring whether to apply the adaptive interpolation filter for inter prediction through a high level syntax of a sequence parameter set (SPS), a picture parameter set (PPS), and a slice header; when whether to apply the adaptive interpolation filter for the intra prediction is indicated to be true, an acquiring unit acquiring tap information of the adaptive interpolation filter for the intra prediction; and when whether to apply the adaptive interpolation filter for the inter prediction is indicated to be true, an acquiring unit acquiring tap information of the adaptive interpolation filter for the inter prediction.

### Advantageous Effects

An object of the present invention is to provide a method and an apparatus for selecting a pixel interpolation filter used in intra prediction and intra prediction to be adaptively used in consideration of image resolution, encoding and decoding environment, encoding efficiency, and the like.

It is to be understood, however, that the technical problem of the present invention is not limited to the above-described technical problem, and other technical problems may exist.

An object of the present invention is to provide a video coding method and apparatus for selecting a pixel interpolation filter used in intra prediction and intra prediction to be adaptively used in consideration of image resolution, encoding and decoding environment, encoding efficiency, and the like, thereby improving the encoding efficiency.

According to an embodiment of the present invention, the encoding performance and complexity can be selected by transmitting information on a type of an interpolation filter on a per sequence basis.

According to an embodiment of the present invention, the encoding performance can be improved by encoding information of one or more encoded blocks in one or more groups.

### DESCRIPTION OF DRAWINGS

FIG. 1 is a block diagram showing a configuration of a video encoding apparatus according to an embodiment of the present invention.

FIG. 2 is a block diagram illustrating a configuration of a video decoding apparatus according to an embodiment of the present invention.

FIG. 3 is a flowchart illustrating operations of a motion compensation performing unit including an interpolation filter application unit according to an embodiment or the present invention.

FIG. 4 is a flowchart illustrating operations of an intra prediction pixel generation unit including an interpolation filter application unit according to an embodiment of the present invention.

FIG. 5 is a flowchart illustrating operations of an interpolation filter application unit for applying an adaptive interpolation filter according to an embodiment of the present invention.

FIG. 6 is a view illustrating an example of a syntax for an adaptive interpolation filter according to an embodiment of the present invention.

FIG. 7 is a view illustrating an example of a syntax for an adaptive interpolation filter of intra prediction and inter prediction according to an embodiment of the present invention.

### BEST MODE

Hereinafter, embodiments of the present invention will be described in detail with reference to the drawings attached thereto, so that those skilled in the art can easily carry out the present invention. The present invention may, however, be embodied in many different forms and should not be construed as limited to the embodiments set forth herein. In order to clearly illustrate the present invention, parts not related to the description are omitted, and similar parts are denoted by like reference characters throughout the specification.

Throughput this specification, when a part is referred to as being “connected” to another part, it includes not only a case where they are directly connected but also a case where the part is electrically connected with another part in between.

In addition, when part is referred to as “comprising” an element throughout the specification, it is understood that the element may include other elements as well, without departing from the other elements unless specifically stated otherwise.

The term “a step of doing something” or “a step of something” used throughout this specification does not mean “a step for something”.

Also, the terms first, second, etc. may be used to describe various components, but the components should not be limited by the terms. The terms are used only for the purpose of distinguishing one component from another.

In addition, the components shown in the embodiments of the present invention are shown independently to represent different characteristic functions, but that does not mean that each component consists of separate hardware or one software constituent unit. That is, each component is described by arranging each component convenience of explanation, and at least two components of components may be combined to form one component or one component may be partitioned into a plurality of components to perform functions. The integrated embodiments and the separate embodiments of each of these components are also included in the scope of the present invention without departing from the essence of the present invention.

In the various embodiments of the invention described herein, an interpolation filter may be generically referred to as including creating pixels that are located between two adjacent pixels using one or more pixels. The application range of the interpolation filter is not limited only to the inter prediction, but may be generically referred to as including an interpolation filter for pixels spatially adjacent in the intra prediction.

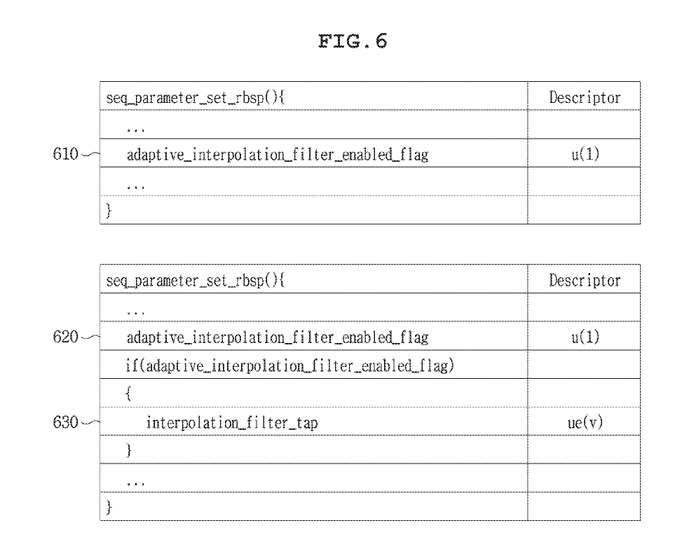

Hereinafter, a video coding method and apparatus using an adaptive interpolation filter according to an embodiment of the present invention will be described in detail with reference to FIG. 6.

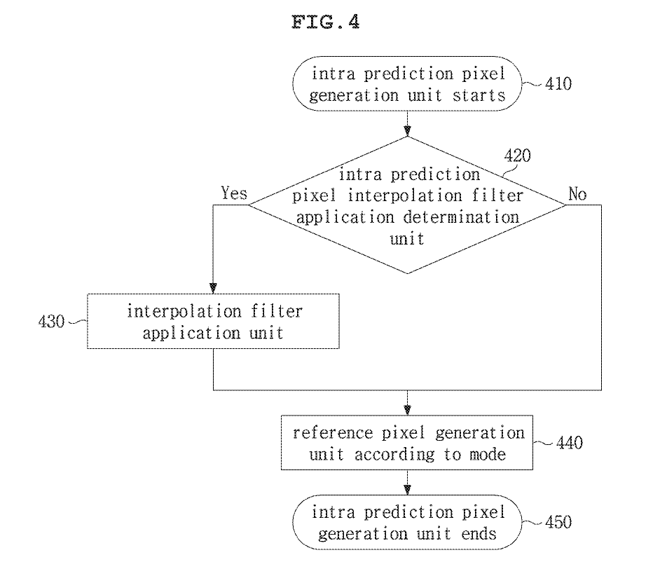

FIG. 4 is a flowchart illustrating operations of an intra prediction pixel generation unit including an interpolation filter application unit according to an embodiment of the present invention.

The intra prediction pixel generation unit according to an embodiment includes an intra prediction pixel interpolation filter application determination unit 420, an interpolation filter application unit 430, and a reference pixel generation unit 440 according to a mode. The intra prediction pixel interpolation filter application determination unit 420 determines whether to apply an interpolation filter for the current intra prediction mode, so that when it is necessary to apply the interpolation filter, the interpolation filter is applied, and otherwise, reference pixel generation is performed according to mode. The interpolation filter application unit 430 determines an interpolation position according to an intra prediction mode of the current block and applies the interpolation filter. The reference pixel generation unit 440 according to the mode generates the resulting prediction pixels using the pixels spatially adjacent to the intra prediction mode information and reference pixels to which the interpolation filter is applied.

### MODE FOR INVENTION

Hereinafter, embodiments of the present invention will be described in detail with reference to the drawings attached thereto, so that those skilled in the art can easily carry out the present invention. The present invention may, however, be embodied in many different forms and should not be construed as limited to the embodiments set forth herein. In order to clearly illustrate the present invention, parts not related to the description are omitted, and similar parts are denoted by like reference characters throughout the specification.

Throughout this specification, when a part is referred to as being “connected” to another part, it includes not only a case where they are directly connected but also a case where the part is electrically connected with another part in between.

In addition, when a part referred to as “comprising” an element throughout the specification, it is understood that the element may include other elements as well, without departing from the other elements unless specifically stated otherwise.

The team “a step of doing something” or “a step of something” used throughout this specification does not mean “a step for something”.

Also, the terms first, second, etc. may be used to describe various components, but the components should not be limited by the terms. The terms are used only for the purpose of distinguishing one component from another.

In addition, the components shown in the embodiments of the present invention are shown independently to represent different characteristic functions, but that does not mean that each component consists of separate hardware or one software constituent unit. That is, each component is described by arranging each component convenience of explanation, and at least two components of components may be combined to form one component or one component may be partitioned into a plurality of components to perform functions. The integrated embodiments and the separate embodiments of each of these components are also included in the scope of the present invention without departing from the essence of the present invention.

In the various embodiments of the invention described herein, an interpolation filter may be generically referred to as including creating pixels that are located between two adjacent pixels using one or more pixels. The application range of the interpolation filter is not limited only to the inter prediction, but may be generically referred to as including an interpolation filter for pixels spatially adjacent in the intra prediction.

Hereinafter, a video coding method and apparatus using an adaptive interpolation filter according to an embodiment of the present invention will be described in detail with reference to FIG. 6.

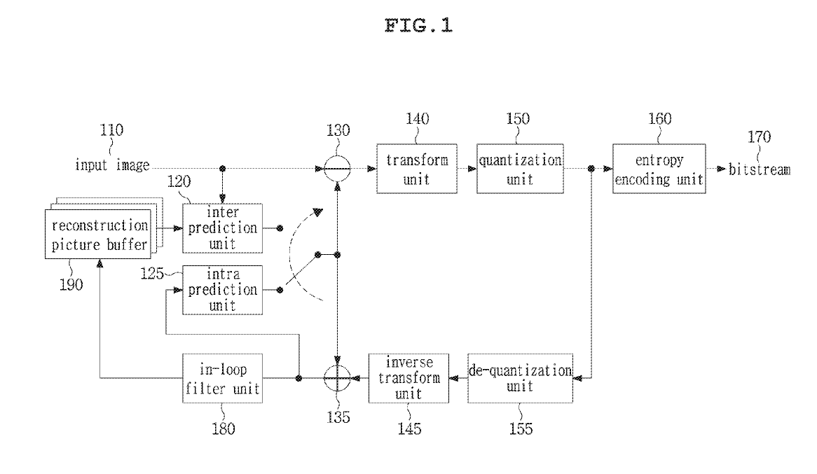

FIG. 1 is a block diagram showing a configuration of a video encoding method and apparatus according to an embodiment of the present invention.

The video encoding method and apparatus according to an embodiment includes an inter prediction unit 120, an intra prediction unit 125, a subtractor 130, a transform unit 140, a quantization unit 150, an entropy encoding unit 160, an inverse transform unit 145, a de-quantization unit 155, an adder 135, an in-loop filter unit 180, and a reconstructed picture buffer 190.

The inter prediction unit 120 generates a prediction signal by performing motion prediction using the input image 110 and the reconstructed image stored in the reconstructed picture buffer 190.

The intra prediction unit 125 performs spatial prediction using pixel values of pre-reconstructed neighboring blocks that are adjacent to the current block to be encoded, thereby generating a prediction signal.

The subtractor 130 generates a residual signal using the input image and the prediction signal generated from the inter prediction unit 120 or the intra prediction unit 125.

The transform unit 140 and the quantization unit 150 perform transform and quantization on the residual signal generated through the subtractor 130, thereby generating a quantized coefficient.

The entropy encoding unit 160 performs entropy encoding on encoding information such as quantized coefficients and syntax elements defined in the video encoder, thereby outputting a bitstream.

The inverse transform unit 145 and the de-quantization unit 155 receive the quantization coefficients and perform de-quantization and inverse transformation in order, thereby generating a reconstructed residual signal.

The adder 135 generates a reconstructed signal using the reconstructed residual signal and the prediction signal generated through the inter prediction unit 120 or the intra prediction unit 125.

The reconstructed signal is transferred to the in-loop filter unit 180. The reconstructed picture to which filtering is applied is stored in the reconstructed picture buffer 190 and used as a reference picture in the inter prediction unit 120.

[symbol]

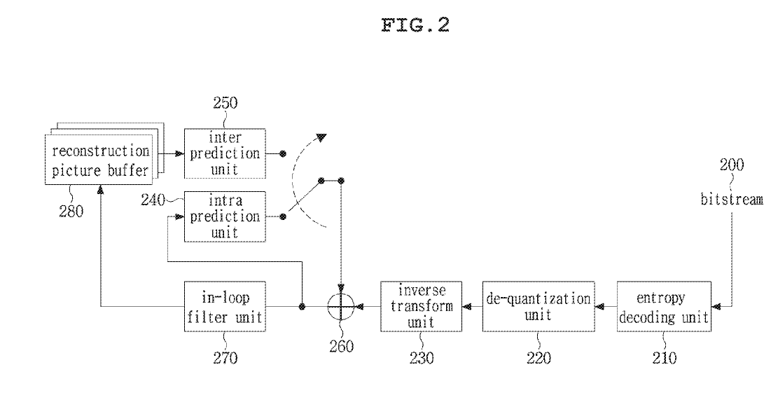

FIG. 2 is a block diagram illustrating a configuration of a video decoding apparatus and method according to an embodiment of the present invention.

The video decoding apparatus and method according to the embodiment includes an entropy decoding unit 210, a de-quantization unit 220, an inverse transform unit 230, an intra prediction unit 240, an inter prediction unit 250, an adder 260, an in-loop filter unit 270, and a reconstructed picture buffer 280.

The entropy decoding unit 210 decodes the input bitstream 200 and outputs decoding information such as syntax elements and quantized coefficients.

The de-quantization unit 220 and the inverse transform unit 230 receive the quantization coefficients and perform de-quantization and inverse transformation in order, thereby outputting a residual signal.

The intra prediction unit 240 performs spatial prediction using pixel values of the pre-decoded neighboring blocks adjacent to the current block to be decoded, thereby generating a prediction signal.

The inter prediction unit 250 performs motion compensation using a motion vector extracted from the bitstream and reconstructed image stored in the reconstructed picture buffer 280, thereby generating a prediction signal.

The prediction signal output from the intra prediction unit 240 and the inter prediction unit 250 is added to the residual signal through the adder 260, and accordingly the reconstructed image is included in the reconstructed signal generated on a per block basis.

The reconstructed image is transferred to the in-loop filter unit 270. The reconstructed picture to which filtering applied is stored in the reconstructed picture buffer 280 and used as a reference picture in the inter prediction unit 250.

[symbol]

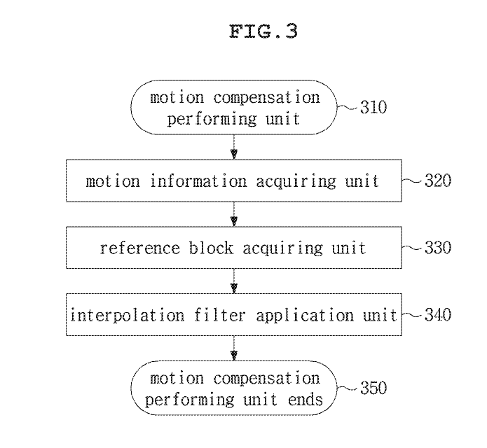

FIG. 3 is a flowchart illustrating operations of motion compensation performing unit including an interpolation filter application unit according to an embodiment of the present invention.

The motion compensation performing unit according to an embodiment includes a motion information acquisition unit 320, a reference block acquisition unit 330, and an interpolation filter application unit 340. The motion information acquisition unit 320 shown in FIG. 3 generates motion information of a current block from motion information of blocks spatially and temporally adjacent to motion information acquired from the bitstream. The reference block acquisition unit 330 acquires a reference block from the reference picture on the basis of the generated motion information of the current block, thereby generating a prediction block. Herein, when the motion information performs bidirectional prediction, two reference blocks are acquired to generate one prediction block. The interpolation filter application unit 340 performs interpolation between pixels in the prediction block using the generated prediction block and the motion information. The resulting prediction block generated by the interpolation filter application unit is output from the motion compensation performing unit.

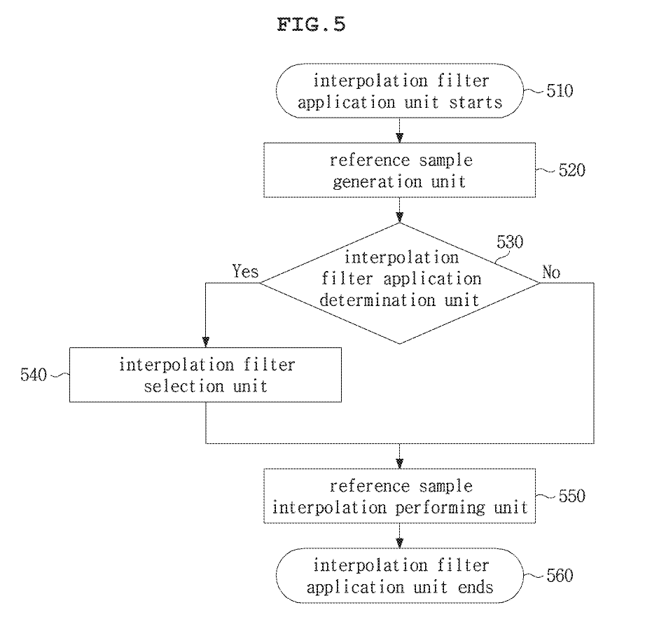

FIG. 5 is a flowchart illustrating operations of is an interpolation filter application unit that applies an adaptive interpolation filter according to an embodiment of the present invention.

The interpolation filter application unit that applies an adaptive interpolation filter according to an embodiment of the present invention includes a reference sample generation unit 520, an adaptive interpolation filter application determination unit 530, an interpolation filter selection unit 540, and a reference sample interpolation performing unit 550. The reference sample generation unit acquires reference samples generated using motion information in inter prediction and acquires reference samples spatially adjacent in intra prediction. The adaptive interpolation filter application determination unit 530 determines adaptive interpolation filter application among high level syntax such as a sequence parameter set (SPS), a picture parameter set (PPS), and a slice header. The interpolation filter selection unit 540 selects one filter of interpolation filter predefined in the standard or transmitted filter using the interpolation filter information transmitted in the high-level syntax. For example, one of a 4-tap interpolation. filter, a 6-tap interpolation filter, and an 8-tap interpolation filter may be selected, and the selection of the interpolation filter is performed using the transmitted encoding information or according to a predefined selection method. The reference sample interpolation performing unit 550 performs interpolation on the reference sample using the interpolation filter selected by the interpolation filter selection unit 540 or an interpolation filter defined in the standard.

[symbol]

FIG. 6 is a view illustrating an example of a syntax for an adaptive interpolation filter according to an embodiment of the present invention.

The syntax for the adaptive interpolation filter according to one embodiment includes transmitting whether or not to use the adaptive interpolation filter (610) by using a high level syntax such as a sequence parameter set (SPS), a picture parameter set (PPS), a slice header, and the like. In addition, only information on whether to apply the adaptive interpolation filter (610) may be transmitted, and interpolation filter tap information (630) is additionally transmitted together with the information on whether to to apply the adaptive interpolation filter (620), when whether to apply the adaptive interpolation filter (620) is indicated to be true. A syntax table shown in FIG. 6 shows an example of transmitting information on the adaptive interpolation filter using a sequence parameter set (SPS).

The interpolation filter tap information 630 according to an embodiment includes directly transmitting the number of filter taps or transmitting the same in a form of an index indicating one of a plurality of filter tap types previously defined in the standard. Here, when the number of filter taps is directly transmitted, a difference value obtained by subtracting a predetermined value from the number of filter taps may be transmitted. The syntax table shown in FIG. 6 shows an example of transmitting information on the adaptive interpolation filter by using a sequence parameter set (SPS).

[symbol]

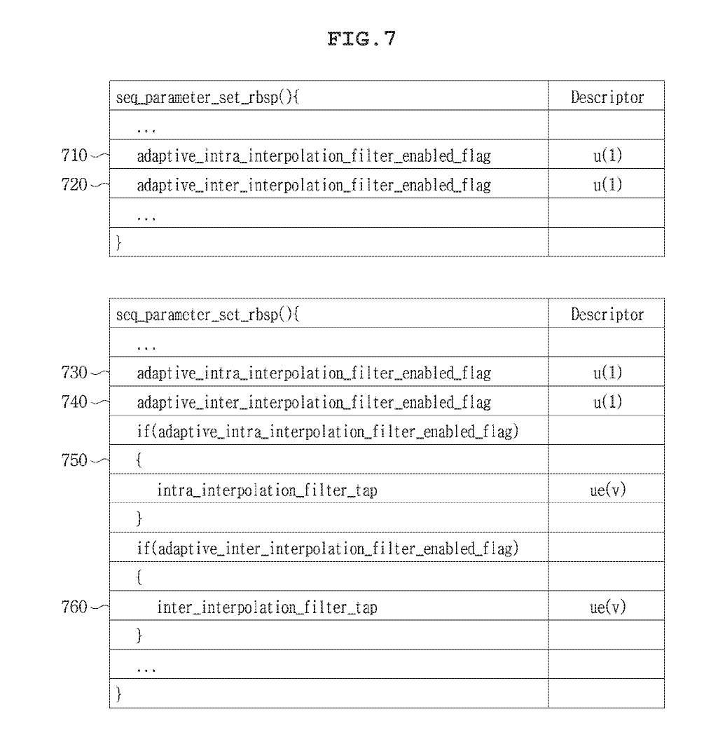

FIG. 7 is a view illustrating an example of a syntax for an adaptive interpolation filter of intra prediction and inter prediction according to an embodiment of the present invention.

The syntax for the adaptive interpolation filter of intra prediction and inter prediction according to an embodiment of the present invention includes transmitting whether to apply the adaptive interpolation filter in intra prediction (710) and whether to apply the adaptive interpolation filter in inter prediction (720) by using a high level syntax such as a sequence parameter set (SPS), a picture parameter set (PPS), and a slice header. In addition, only information on whether to apply the adaptive interpolation filter in the intra prediction (710) and whether to apply the adaptive interpolation filter in inter prediction (720) may be transmitted, and interpolation filter tap information 750 and 760 are additionally transmitted, together with the information on whether to apply the adaptive interpolation filter (730 and 740) when whether to apply the adaptive interpolation filter (730 and 740) is indicated to be true. The syntax table shown in FIG. 7 shows an example of transmitting information on the adaptive interpolation filter using a sequence parameter set (SPS).

The interpolation filter tap information 750 of intra prediction and the interpolation filter tab information of inter prediction according to an embodiment includes directly transmitting the number of filter taps or transmitting the same in a form of an index type indicating one of a plurality of filter tab predefined in the standard. Here, when the number of filter taps is directly transmitted, a difference value obtained by subtracting a predetermined value from the number of filter taps may be transmitted. The syntax table shown in FIG. 7 shows an example of transmitting information on the adaptive interpolation filter using a sequence parameter set (SPS).

### INDUSTRIAL APPLICABILITY

The present invention can be used for manufacturing such as broadcasting equipment manufacturing, terminal manufacturing, and the like, and industries related to source technology, as industries related to video encoding/decoding.

### LIST FREE TEXT

No

1. A video encoding and decoding method, comprising:
acquiring a spatially and temporally adjacent reference samples;
determining whether to apply an adaptive interpolation filter acquired from a bitstream; and
when whether to apply the adaptive interpolation filter is indicated to be true, performing interpolation of the reference samples using information for the acquired reference samples and the interpolation filter.

2. The method of claim 1, wherein the determining of whether to apply the adaptive interpolation filter includes:
acquiring whether to apply the adaptive interpolation filter through a high level syntax of one of a sequence parameter set (SPS), a picture parameter set (PPS), and a slice header.

3. The method of claim 1, wherein the determining of whether to apply the adaptive interpolation filter includes:
acquiring whether to apply the adaptive interpolation filter for intra prediction through a high level syntax of one of a sequence parameter set (SPS), a picture parameter set (PPS), and a slice header;
acquiring whether to apply the adaptive interpolation filter for inter prediction through a high level syntax of a sequence parameter set (SPS), a picture parameter set (PPS), and a slice header;
when whether to apply the adaptive interpolation filter for the intra prediction is indicated to be true, acquiring tap information of the adaptive interpolation filter for the intra prediction; and
when whether to apply the adaptive interpolation filter for the inter prediction is indicated to be true, acquiring tap information of the adaptive interpolation filter for the inter prediction.

4. The method of claim 1, wherein the determining of whether to apply the adaptive interpolation filter includes:
acquiring whether to apply the adaptive interpolation filter for intra prediction through a high level syntax of one of a sequence parameter set (SPS), a picture parameter set (PPS), and a slice header;
acquiring whether to apply the adaptive interpolation filter for inter prediction through a high level syntax of a sequence parameter set (SPS), a picture parameter set (PPS), and a slice header;
when whether to apply the adaptive interpolation filter for the intra prediction is indicated to be true, acquiring tap information of the adaptive interpolation filter for the intra prediction;
when the acquired tap information of the adaptive interpolation filter for the intra prediction is index information, acquiring the number of interpolation filter taps for the corresponding to the acquired index;
when whether to apply the adaptive interpolation filter for the inter prediction is indicated to be true, acquiring tap information of the adaptive interpolation filter for the inter prediction; and
when the acquired tap information of the adaptive interpolation filter for the inter prediction is index information, acquiring the number of interpolation filter taps for the inter prediction corresponding to the acquired index.

5. A video encoding and decoding apparatus, performing:
acquiring a spatially and temporally adjacent reference samples;
determining whether to apply an adaptive interpolation filter acquired from a bitstream; and
when whether to apply the adaptive interpolation filter is indicated to be true, performing interpolation of the reference samples using information for the acquired reference samples and the interpolation filter.

6. The apparatus of claim 5, wherein the determining of whether to apply the adaptive interpolation filter includes:
acquiring whether to apply the adaptive interpolation filter through a high level syntax of one of a sequence parameter set (SPS), a picture parameter set (PPS), and a slice header.

7. The apparatus of claim 5, wherein the determining of whether to apply the adaptive interpolation filter includes:
acquiring whether to apply the adaptive interpolation filter for intra prediction through a high level syntax of one of a sequence parameter set (SPS), a picture parameter set (PPS), and a slice header;
acquiring whether to apply the adaptive interpolation filter for inter prediction through a high level syntax of a sequence parameter set (SPS), a picture parameter set (PPS), and a slice header;
when whether to apply the adaptive interpolation filter for the intra prediction is indicated to be true, acquiring tap information of the adaptive interpolation filter for the intra prediction; and
when whether to apply the adaptive interpolation filter for the inter prediction is indicated to be true, acquiring tap information of the adaptive interpolation filter for the inter prediction.

8. The apparatus of claim 5, wherein the determining of whether to apply the adaptive interpolation filter includes:
acquiring whether to apply the adaptive interpolation filter for intra prediction through a high level syntax of one of a sequence parameter set (SPS), a picture parameter set (PPS), and a slice header;
acquiring whether to apply the adaptive interpolation filter for inter prediction through a high level syntax of a sequence parameter set (SPS), a picture parameter set (PPS), and a slice header;
when whether to apply the adaptive interpolation filter for the intra prediction is indicated to be true, acquiring tap information of the adaptive interpolation filter for the intra prediction;
when the acquired tap information of the adaptive interpolation filter for the intra prediction is index information, acquiring the number of interpolation filter taps for the intra prediction corresponding to the acquired index;
when whether to apply the adaptive interpolation filter for the inter prediction is indicated to be true, acquiring tap information of the adaptive interpolation filter for the inter prediction; and
when the acquired tap information of the adaptive interpolation filter for the inter prediction is index information, acquiring the number of interpolation filter taps for the inter prediction corresponding to the acquired index.
